(19) United States
(12) Patent Application Publication
(10) Pub. No.: US 2015/0153458 A1
(43) Pub. Date: Jun. 4, 2015

(54) HANDLING EPHEMERIS EXTENSION DATA

(71) Applicants: Jari Tapani Syrjarinne, Tampere (FI); Kimmo Marko Tapani Alanen, Metsakansa (FI); Jani Mikael Käppi, Ylojarvi (FI)

(72) Inventors: Jari Tapani Syrjarinne, Tampere (FI); Kimmo Marko Tapani Alanen, Metsakansa (FI); Jani Mikael Käppi, Ylojarvi (FI)

(73) Assignee: Nokia Corporation, Espoo (FI)

(21) Appl. No.: 14/364,298

(22) PCT Filed: Dec. 22, 2011
(86) PCT No.: PCT/IB2011/055909

§ 371 Date: Aug. 29, 2014

(51) Int. Cl. G01S 19/25; G01S 19/37

(52) U.S. Cl. CPC G01S 19/258; G01S 19/37

(57) ABSTRACT

Apparatus comprises: one or more memories configured to store data sets for each of plural positioning satellites, the data set for a satellite comprising ephemeris extension data and data relating to a lifetime or expiry of the ephemeris extension data, wherein the data relating to a lifetime or expiry of the ephemeris extension data is different for at least two satellites; and one or more processors. The processors are configured to execute computer code in the one or more memories such as to perform a method comprising: identifying one or more satellites for which ephemeris extension data is no longer valid; identifying one or more satellites for which ephemeris extension data is valid; determining whether to calculate a location based on the one or more satellites for which the stored ephemeris extension data is valid and, in response to a negative determination; sending a request for new ephemeris extension data; receiving new ephemeris extension data; storing the new ephemeris extension data; and using the new ephemeris extension data in calculating a location of the apparatus.

### FIELD OF THE INVENTION

This invention relates to handling ephemeris extension data.

### BACKGROUND TO THE INVENTION

Assistance data is crucial for a satellite positioning receiver, such as a Global Positioning System (GPS) receiver, to provide location fixes rapidly after starting up.

Assistance data typically consists of a set of information elements carrying reference location, reference time and satellite clock and orbit data. Satellite clock and orbit data together are typically called ephemeris data. Ephemeris data, together with other aiding means available in a mobile phone (such as reference frequency from the cellular modem) will boost and accelerate the performance of an integrated GPS receiver so that a first fix can usually be provided in 5-10 seconds with a 5 metre accuracy. In comparison, a GPS receiver without any assistance cannot provide the first fix in less than 30-40 seconds even in optimal signal reception conditions.

Several advances have been made in the recent years to extend the life-time of the assistance data to make it readily available for the GPS receivers, so that the mobile phone does not need to send an assistance data request via a network every time its GPS receiver is activated. The typical life-time of the assistance data is 2-4 hours, after which the data needs to be refreshed from the satellites or from servers on the mobile phone network or a network attached thereto. The life-time is typically limited by the short-lived ephemeris data, which at maximum has a validity period of approximately 4 hours, after which the quality of the satellite position information (orbit) quickly degrades. In the prior art, efforts in extending the overall life-time of the assistance data have been focusing on extending the life-time of the ephemeris data, especially the orbit data.

There are several commercial solutions for ephemeris extensions. Typical for all previous ephemeris extension solutions is that they tend to provide extensions for a fixed period (e.g. 7 days). Also, the quantity of data (in bytes) transferred to the receiver is also fixed/predictable. Providing extensions for fixed periods and of fixed size provides some simplicity when designing applications for mobile devices and when operating ephemeris extension services.

### SUMMARY OF THE INVENTION

A first aspect of the invention provides apparatus comprising:
one or more memories configured to store data sets for each of plural positioning satellites, the data set for a satellite comprising ephemeris extension data and data relating to a lifetime or expiry of the ephemeris extension data, wherein the data relating to a lifetime or expiry of the ephemeris extension data is different for at least two satellites; and
one or more processors configured to execute computer code in the one or more memories such as to perform a method comprising:
   identifying one or more satellites for which ephemeris extension data is no longer valid;
   identifying one or more satellites for which ephemeris extension data is valid;
   determining whether to calculate a location based on the one or more satellites for which the stored ephemeris extension data is valid and, in response to a negative determination:
      sending a request for new ephemeris extension data;
      receiving new ephemeris extension data;
      storing the new ephemeris extension data; and
      using the new ephemeris extension data in calculating a location of the apparatus.

The computer code may be configured to cause the processor to perform determining whether to calculate a location by:
identifying one or more satellites that are currently usable in obtaining a location fix;
determining whether valid ephemeris extension data is present for a threshold number of the satellites usable in obtaining a location fix;
on a positive determination, using the valid ephemeris extension data to obtain a location fix; and
on a negative determination, requesting new ephemeris extension data

The computer code may be configured to cause the processor to perform sending a request for new ephemeris extension data by sending a request for ephemeris extension data for satellites for which ephemeris extension data is no longer valid.

The computer code may be configured to cause the processor to perform sending a request for new ephemeris extension data by sending a request for ephemeris extension data for all satellites for which ephemeris extension data is no longer valid.

The computer code may be configured to cause the processor to perform sending a request for new ephemeris extension data comprises by a request for ephemeris extension data for all satellites for which ephemeris extension data is stored in the mobile device, whether or not the ephemeris extension data is valid.

The data relating to a lifetime of the ephemeris extension data may indicate an expiry time.

The data relating to a lifetime of the ephemeris extension data may indicate a validity period and a start time.

The computer code may be configured to cause the processor to perform receiving a file comprising plural data sets each corresponding to a different positioning satellite.

The computer code may be configured to cause the processor to perform receiving plural files, each file comprising a data set for a different positioning satellite.

A second aspect of the invention provides a method comprising:
storing in a mobile device data sets for each of plural positioning satellites, the data set for a satellite comprising ephemeris extension data and data relating to a lifetime or expiry of the ephemeris extension data, wherein the data relating to a lifetime or expiry of the ephemeris extension data is different for at least two satellites;
identifying one or more satellites for which ephemeris extension data is no longer valid;
identifying one or more satellites for which ephemeris extension data is valid;
determining whether to calculate a location based on the one or more satellites for which the stored ephemeris extension data is valid and, in response to a negative determination:
   sending a request for new ephemeris extension data;
   receiving new ephemeris extension data;
   storing the new ephemeris extension data; and
   using the new ephemeris extension data in calculating a location of the mobile device.

Determining whether to calculate a location may comprise:
identifying one or more satellites that are currently usable in obtaining a location fix;
determining whether valid ephemeris extension data is present for a threshold number of the satellites usable in obtaining a location fix;
on a positive determination, using the valid ephemeris extension data to obtain a location fix; and
on a negative determination, requesting new ephemeris extension data

Sending a request for new ephemeris extension data may comprise sending a request for ephemeris extension data for satellites for which ephemeris extension data is no longer valid.

Sending a request for new ephemeris extension data may comprise sending a request for ephemeris extension data for all satellites for which ephemeris extension data is no longer valid.

Sending a request for new ephemeris extension data may comprise sending a request for ephemeris extension data for all satellites for which ephemeris extension data is stored in the mobile device, whether or not the ephemeris extension data is valid.

The data relating to a lifetime of the ephemeris extension data indicates an expiry time.

The data relating to a lifetime of the ephemeris extension data may indicate a validity period and a start time.

The method may comprise receiving a file comprising plural data sets each corresponding to a different positioning satellite.

The method may comprise receiving plural files, each file comprising a data set for a different positioning satellite.

A third aspect of the invention provides computer readable medium having non-transiently stored therein computer code that when executed by one or more processors of a mobile device causes them to perform a method comprising:
storing data sets for each of plural positioning satellites, the data set for a satellite comprising ephemeris extension data and data relating to a lifetime or expiry of the ephemeris extension data, wherein the data relating to a lifetime or expiry of the ephemeris extension data is different for at least two satellites;
identifying one or more satellites for which ephemeris extension data is no longer valid;
identifying one or more satellites for which ephemeris extension data is valid;
determining whether to calculate a location based on the one or more satellites for which the stored ephemeris extension data is valid and, in response to a negative determination:
   sending a request for new ephemeris extension data;
   receiving new ephemeris extension data;
   storing the new ephemeris extension data; and
   using the new ephemeris extension data in calculating a location of the mobile device.

The computer code when executed by the one or more processors of the mobile device may cause them to perform determining whether to calculate a location by:
identifying one or more satellites that are currently usable in obtaining a location fix;
determining whether valid ephemeris extension data is present for a threshold number of the satellites usable in obtaining a location fix;
on a positive determination, using the valid ephemeris extension data to obtain a location fix; and
on a negative determination, requesting new ephemeris extension data

The computer code when executed by the one or more processors of the mobile device may cause them to perform sending a request for new ephemeris extension data by sending a request for ephemeris extension data for satellites for which ephemeris extension data is no longer valid.

The computer code when executed by the one or more processors of the mobile device may cause them to perform sending a request for new ephemeris extension data by sending a request for ephemeris extension data for all satellites for which ephemeris extension data is no longer valid.

The computer code when executed by the one or more processors of the mobile device may cause them to perform sending a request for new ephemeris extension data by sending a request for ephemeris extension data for all satellites for which ephemeris extension data is stored in the mobile device, whether or not the ephemeris extension data is valid.

The data relating to a lifetime of the ephemeris extension data may indicate an expiry time.

The data relating to a lifetime of the ephemeris extension data may indicate a validity period and a start time.

The computer code when executed by the one or more processors of the mobile device may cause them to perform receiving a file comprising plural data sets each corresponding to a different positioning satellite.

The computer code when executed by the one or more processors of the mobile device may cause them to perform receiving plural files, each file comprising a data set for a different positioning satellite.

A fourth aspect of the invention provides a method comprising creating data sets for each of plural positioning satellites, the data set for a satellite comprising ephemeris extension data and data relating to a lifetime or expiry of the ephemeris extension data, wherein the data relating to a lifetime or expiry of the ephemeris extension data is different for at least two satellites.

A fifth aspect of the invention provides a computer readable medium having non-transiently stored therein computer code that when executed by one or more processors of a mobile device causes them to perform a method comprising: creating data sets for each of plural positioning satellites, the data set for a satellite comprising ephemeris extension data and data relating to a lifetime or expiry of the ephemeris extension data, wherein the data relating to a lifetime or expiry of the ephemeris extension data is different for at least two satellites.

A sixth aspect of the invention provides apparatus comprising one or more processors configured to execute computer code stored in one or more memories such as to perform a method comprising: creating data sets for each of plural positioning satellites, the data set for a satellite comprising ephemeris extension data and data relating to a lifetime or expiry of the ephemeris extension data, wherein the data relating to a lifetime or expiry of the ephemeris extension data is different for at least two satellites.

A seventh aspect of the invention provides a method comprising sending data sets for each of plural positioning satellites, the data set for a satellite comprising ephemeris extension data and data relating to a lifetime or expiry of the ephemeris extension data, wherein the data relating to a lifetime or expiry of the ephemeris extension data is different for at least two satellites.

An eighth aspect of the invention provides a computer readable medium having non-transiently stored therein computer code that when executed by one or more processors of a mobile device causes them to perform a method comprising: sending data sets for each of plural positioning satellites, the data set for a satellite comprising ephemeris extension data and data relating to a lifetime or expiry of the ephemeris extension data, wherein the data relating to a lifetime or expiry of the ephemeris extension data is different for at least two satellites.

A ninth aspect of the invention provides apparatus comprising one or more processors configured to execute computer code stored in one or more memories such as to perform a method comprising: sending data sets for each of plural positioning satellites, the data set for a satellite comprising ephemeris extension data and data relating to a lifetime or expiry of the ephemeris extension data, wherein the data relating to a lifetime or expiry of the ephemeris extension data is different for at least two satellites.

### BRIEF DESCRIPTION OF THE DRAWINGS

FIG. 1 is a system for creating and distributing assistance data;

FIG. 2 is a flowchart illustrating processes occurring within the server of FIG. 1;

FIG. 3 is a flowchart illustrating processes occurring within the receiver of FIG. 1;

FIG. 4 shows a graph useful in understanding operation of a receiver according to the invention;

FIG. 5 shows a graph useful in understanding operation of a receiver according to the invention;

FIG. 6a shows a ephemeris extension file useful in understanding operation of a receiver according to the invention;

FIG. 6b shows an ephemeris extension file useful in understanding operation of a receiver according to the invention;

FIG. 7a shows a graph which describes how predicted error in ephemeris is calculated by a receiver according to the invention; and

FIG. 7b is a graph which shows how an ephemeris extension file becomes invalid due to predicted error breaching a pre-defined maximum level.

### DETAILED DESCRIPTION OF EMBODIMENTS

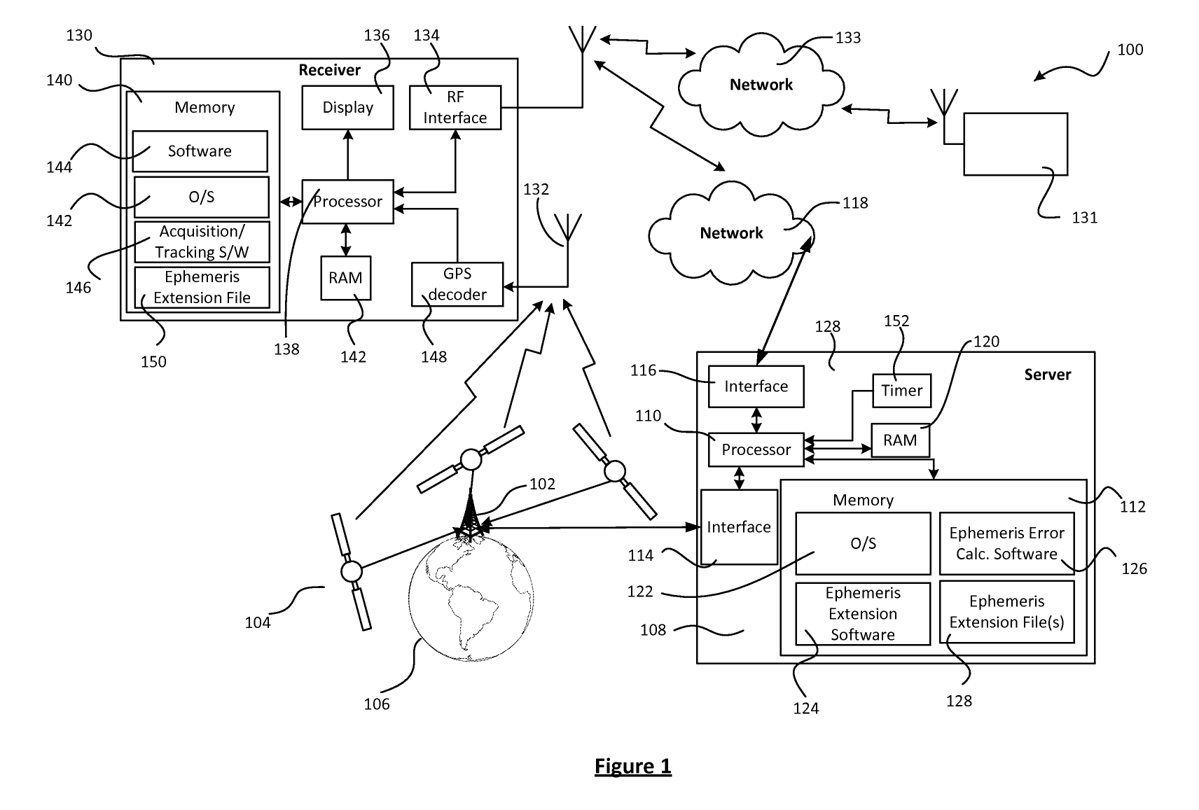

FIG. 1 is a block diagram of a system 100. The system includes the capability of collecting, creating, distributing and using assistance data.

The system 100 includes a satellite system 104. This may be a global or regional radio navigation satellite system such as Global Positioning System (GPS), GLONASS, GALILEO, COMPASS, SBAS (Satellite Based Augmentation System), QZSS (Quaszi-Zenith Satellite System, Japan), IRNSS (Indian Regional Navigation Satellite System, India) or other satellite system. Each of these systems has a separate constellation of satellites, wherein each satellite has a managed orbit. Adjustments for maintenance or orbit corrections are often performed on an individual satellite basis but are performed by the constellation owner or management as needed.

The satellite system 104 provides some assistance data (ephemeris data, almanac data, ionosphere model, UTC model) or other satellite positioning data via a satellite link. This assistance data is combined with ephemeris extension data files created separately of the satellite system 104 and is used to enhance the performance of a wireless receiving device 130, which can also be termed a receiver. The following disclosure uses GPS as an illustrative system, although those skilled in the art will understand how to practise the invention in conjunction with other satellite positioning systems and their constellations.

A network 102 of GPS tracking stations is used to collect data from the orbiting GPS satellites 104 including all the necessary information elements relevant for performance enhancement in the receivers such as ephemeris data. The network 102 may comprise several geographically separated tracking stations, each of which collects satellite data and measurements from plural satellites in the constellation.

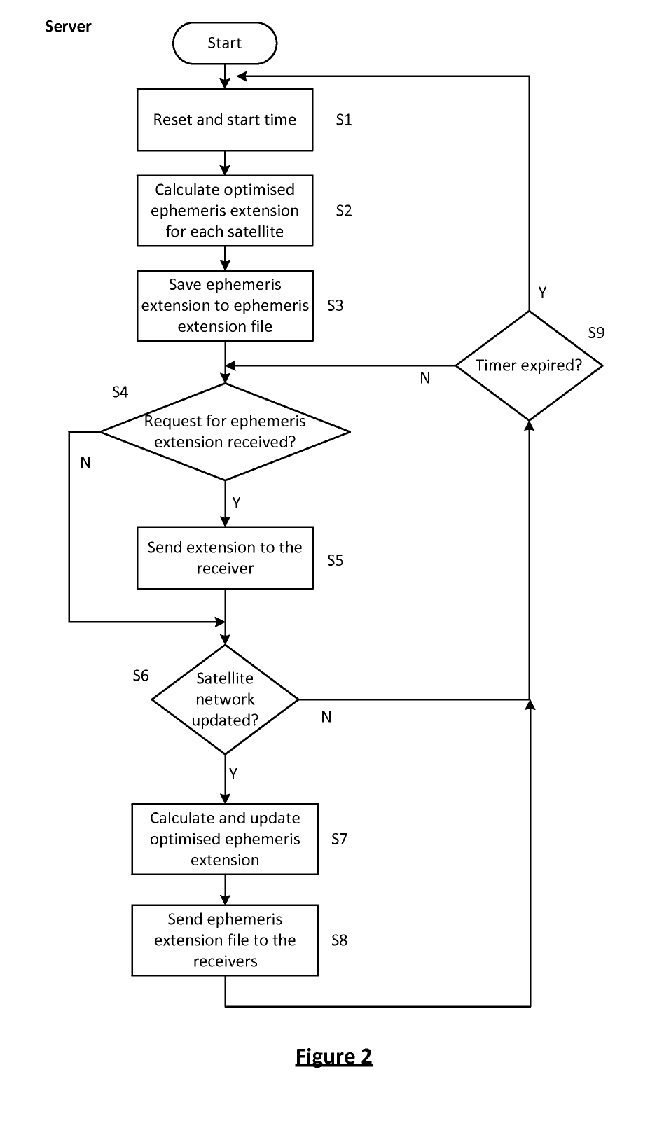

A server 108 is connected to the network 102. The server 108 collects and processes the data and measurements provided by the network 102. An exemplary procedure for processing the satellite data and measurements is described below with reference to FIG. 2. Satellite measurements can include code phase measurements, carrier phase measurements and Doppler measurements for each supported signal and frequency. Satellite data can include ephemeris data (both clock and orbit), almanac data, ionospheric model, UTC model, satellite health information, regional models for ionosphere and/or troposphere, raw navigation data broadcast and data related to the integrity for the satellite signals, payload or services. In some embodiments, the satellite measurements and data are obtained from both the L1 and L2 frequencies and from all the relevant signals (e.g. L1CA, L1C, L2C) on which the GPS satellites 104 transmit. Alternative embodiments may use only one of these frequencies, and/or other frequencies used by other satellite systems or by future versions of the GPS system.

The server 108 comprises a number of components including a processor 110 and a memory 112. The processor 110 is bidirectionally connected to the memory 112. The memory 112 may be a non-volatile memory such as read only memory (ROM) a hard disk drive (HDD) or a solid state drive (SSD). The memory 112 stores, amongst other things, an operating system 122, ephemeris extension calculation software 124, ephemeris error calculation software 126, and an ephemeris extension database file 128 in which ephemeris data sets are stored. The processor 110 is connected to a timer 152. The server 108 includes an interface 116 for communication with a network 118. The interface 116 may be an RF interface, another wireless interface, or a wired interface. The network 118 may be a packet network such as the internet, a local area network, or a telephony network. Volatile memory in the form of Random Access Memory (RAM) 120 is connected to the processor 110. The RAM 120 is used by the processor 110 for the temporary storage of data when executing the software stored in the memory 112. The operating system 122 contains code which, when executed by the processor 110 in conjunction with the RAM 120, controls operation of each of the hardware components of the server 108.

The system 100 also includes a receiver 130. The receiver 130 may be a mobile phone, a handheld navigation system, or an embedded navigation system such as a car safety system. The GPS signal is decoded with the GPS decoder/receiver 148. The receiver 130 is able to receive live telemetry, ephemeris data and almanac data from the satellite system 104 through its GPS antenna 132 and GPS decoder/receiver 148. The receiver 130 is able to receive data such as ephemeris extension files and is able to send server requests via its RF interface 134.

The receiver 130 includes a display 136, a processor 138, and memory 140. The processor 138 is connected to volatile memory in the form of RAM 142. The processor 138 is bidirectionally connected to the memory 140. The memory 140 has stored within, amongst other things, an operating system 142, software 144 for programming the processor 138, satellite acquisition/tracking software 146 and an ephemeris extension file 150 in which ephemeris data sets are stored. The operating system 142 contains code which, when executed by the processor 138 in conjunction with the RAM 142, controls operation of each of the hardware components of the receiver 130.

The operation of the server 108 in some embodiments will now be described with reference to FIG. 2.

A timer 152 (see FIG. 1) is activated and set to zero in step S1. The server 108 receives satellite measurements and data from the satellite tracking stations 102. In step S2, the processor 138 uses the received satellite and measurement data to calculate optimised ephemeris extensions for all satellites in the constellation. The parameterization, model or structure of ephemeris extension data could be different for each satellite. The calculated data comprises multiple data sets, one for each satellite.

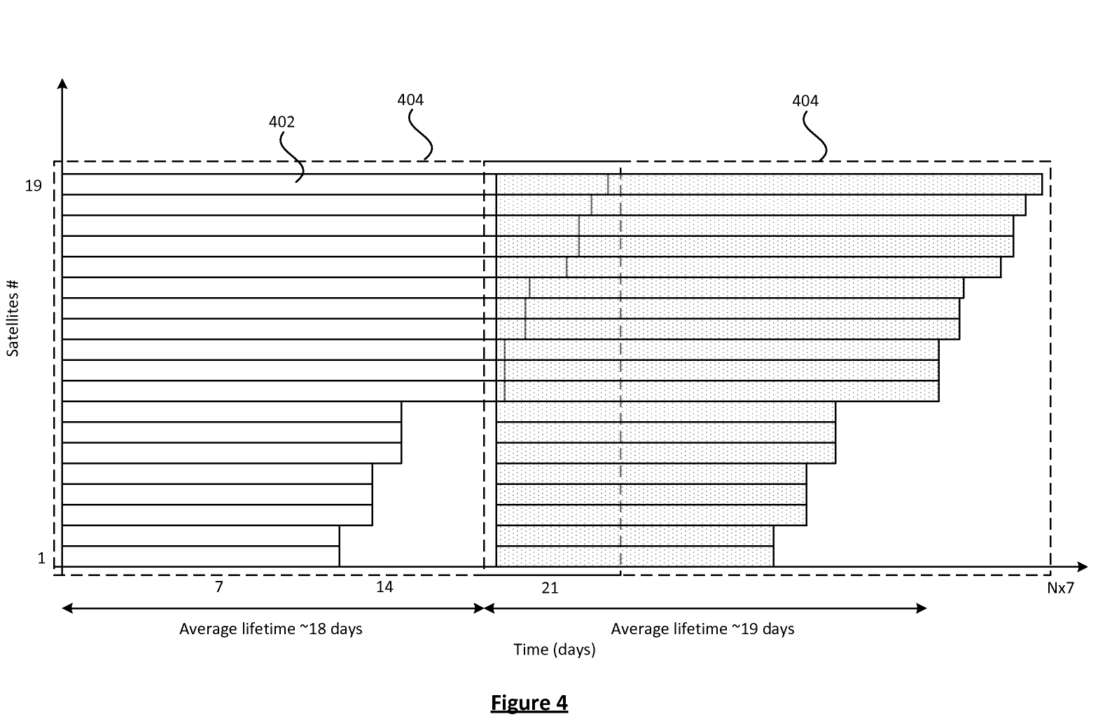

The ephemeris extension file 404 (see FIG. 4) comprises plural data sets or models 402. Each data set 402 relates to a different satellite. Each data set 402 comprises ephemeris extension data for the satellite and an expiry date or date and time (hereafter, expiry date) for the ephemeris extension data. Alternatively, each data set or model can be stored in a separate file. Here, it takes multiple files to make up the ephemeris extension data for a satellite system 104.

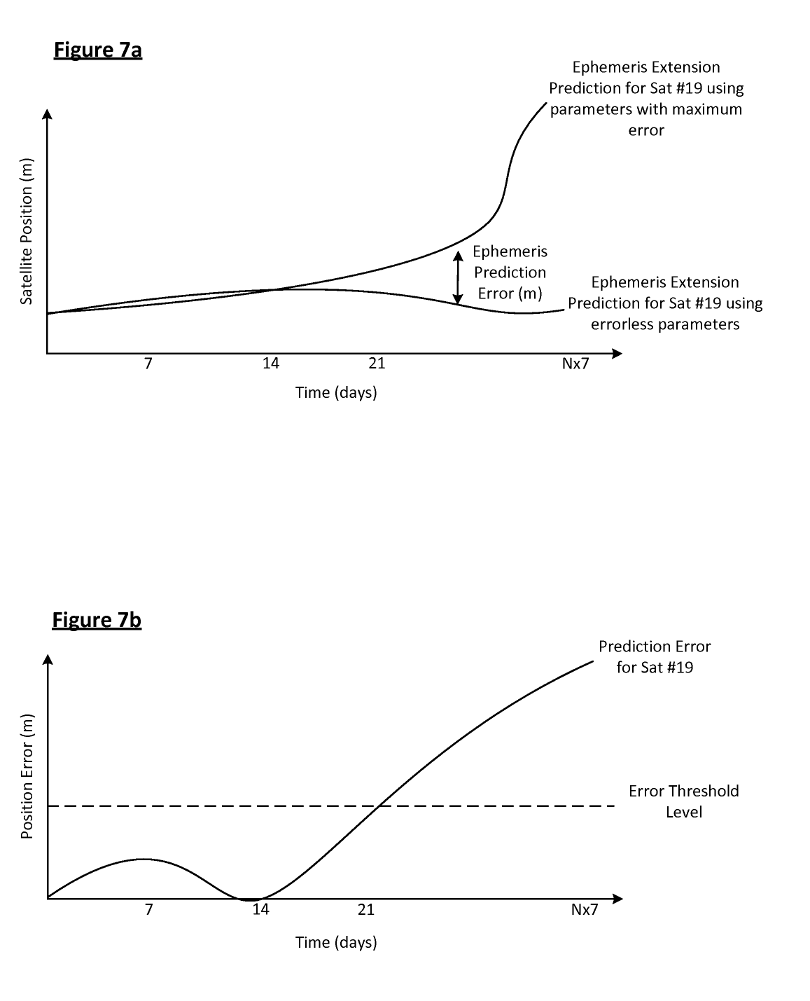

The ephemeris extension data sets are optimised so as to keep the predicted error below a threshold for the longest period of time. This process is described below with reference to FIG. 7b.

FIGS. 7a and 7b show graphically the optimisation aspect of steps S2 and S7 in FIG. 2 for one satellite.

A first ephemeris extension is calculated using model parameters having a maximum error to provide ephemeris prediction error. Ephemeris prediction error may be estimated from model parameters that are orbit errors only. Alternatively, prediction error is estimated from model parameters that are combined clock and orbit errors.

A second ephemeris extension is calculated using the expected model parameters, i.e. model parameters without any error (perfect model parameters).

The server 108 subtracts the ephemeris prediction error values generated in the first ephemeris extension from the ephemeris prediction error values generated in the second ephemeris extension. The result is the predicted error. The predicted error for each satellite is calculated for each of multiple instances over a long time period. The instances may be separated by regular intervals, for instance the predicted error may be calculated for intervals 12 hours apart for 28 days. The time at which the error first exceeds a pre-defined maximum threshold level is the time at which the ephemeris extension for the particular satellite is considered to be no longer valid.

Instead of ensuring that the error is below the threshold, in other embodiments the time at which a percentage, e.g. 95% or 99% of the error, first exceeds a certain threshold.

Each satellite prediction has a unique life-time determined from the expected prediction error. The period for which each ephemeris extension data set is valid is not necessarily the same for different satellites. This could be due to a number of different factors.

The expiry date is the date or date and time at which the error exceeds the threshold.

If the server 108 has received information (e.g. from the server 102 or an operator of a satellite system 104) that a satellite will be affected by an event of rephrasing/orbit change or maintenance at some time in the future, the expiry date for that satellite is set such that the period expires just before the event.

In step S3, the optimised ephemeris extension data set for each satellite is stored in the ephemeris extension file 128. In step S4 the server 108 receives a request for ephemeris extension from the receiver 130 via its network interface 116. In some embodiments, the whole ephemeris extension file (all of the data sets) is requested by the receiver 130. In alternative embodiments, only ephemeris extension data sets for a subset of satellites is requested by the receiver 130. This subset is the subset of satellites which no longer have valid ephemeris extension data. In step S5, the server 108 sends the ephemeris extension data sets to the receiver 130 through the network 118. Upon a negative determination of a request for ephemeris extension being received in step S4, the process skips to step S6.

Along with ephemeris data, the server 108 also receives information about any updates to the satellite network 104. In some embodiments, the update information is sent from the control centre 102. As indicated by step S6, if the satellite network has been updated in any way, the server 108 at step S7 calculates a new optimised ephemeris extension data set, and then overwrites the previously stored optimised ephemeris extension data set with the new optimised ephemeris extension data set. The ephemeris extensions are optimised so as to keep the predicted error below the threshold for the longest period of time.

In step S7, every optimised ephemeris extension data set in the ephemeris extension file 128 may be updated. Alternatively, only the optimised ephemeris extension data sets for the subset of (updated) satellites are updated. In step S8, the updated ephemeris extension data sets are sent to the receivers if push communication is supported. Step S8 is omitted in some embodiments. Steps S7 and S8 are skipped upon negative determination of there having been a satellite network update.

Step S9 is executed upon either completing of step S5, or completing of step S8, dependent upon the determination at step S6. In step S9, the timer 152 initialized in step S1 is analysed. If the expired time is greater than some threshold time, for example 12 hours, then the whole server operation is repeated from step S1. If the expired time is less than the said threshold level, then the server operation is repeated from step S4. In this way, requests from receivers and updates to the network are looked for in between ephemeris extension calculations.

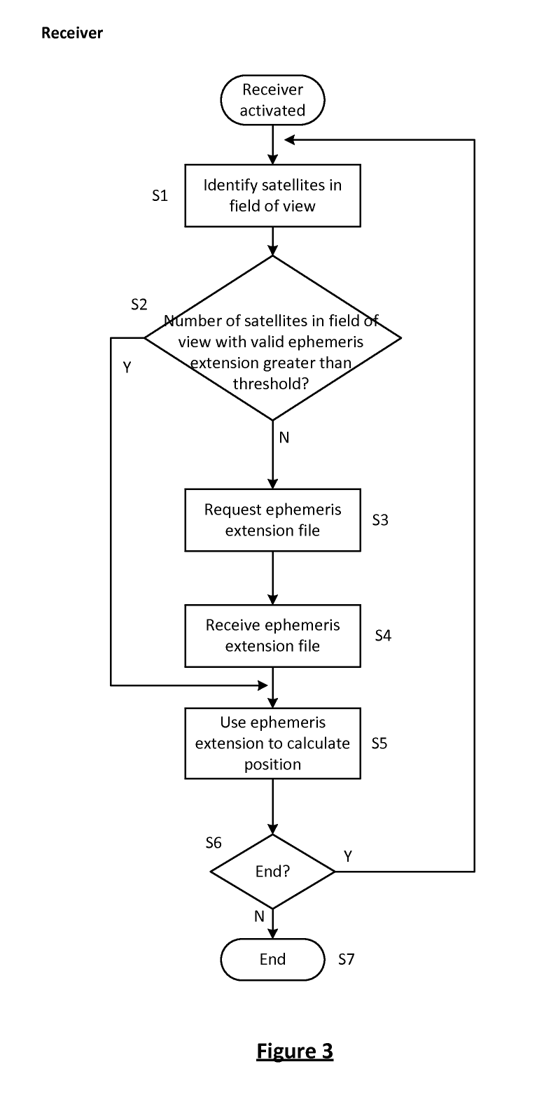

The operation of the receiver 130 will now be described with reference to FIG. 3. The receiver stores ephemeris extension data sets, comprising ephemeris extension data and expiry dates, for each satellite in the ephemeris extension file 150.

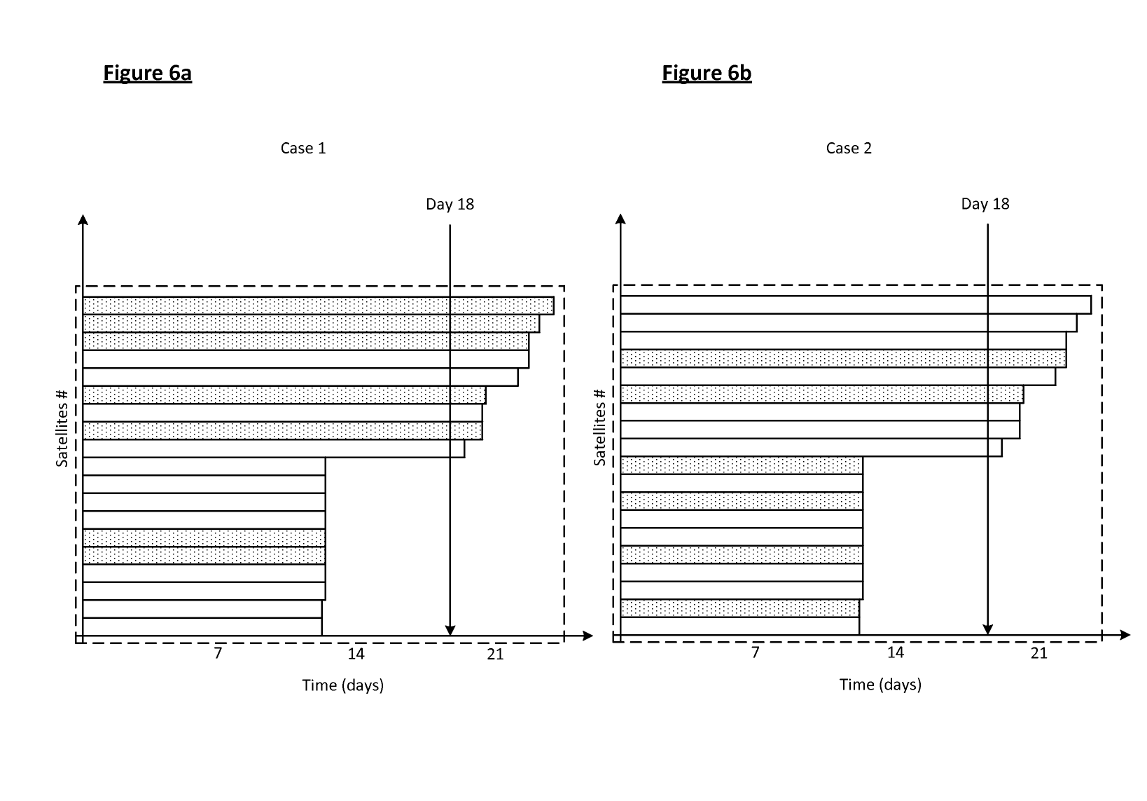

When the receiving device 130 is activated it identifies the satellites 104 within its field of view. These satellites are the satellites which the receiver can use for positioning. In step S2, the receiver 130 validates the stored ephemeris extension data sets, included in its ephemeris extension file 150, by determining whether valid ephemeris extension data is available for a number of satellites greater than a threshold, for example 4 satellites. Details of step S2 are described below with reference to FIGS. 6a and 6b.

FIGS. 6a and 6b show graphically how the receiver 130, using its software 144, makes the determination that an extension file is invalid, or expired, in step S2 of FIG. 3. In FIGS. 6a and 6b, shaded bars indicate satellites that are within the field of view of the receiver 130. The horizontal length of the bars indicates the validity period which starts on the day the ephemeris extension data was calculated by the server and ends on the expiry date. This makes it easy to see which data sets are expired and which are not at a given date, e.g. day 18 (after the calculation of the data by the server 108).

In FIG. 6a, the ephemeris extension file is considered to be valid on day 18 as more than a threshold, e.g. 4, of the satellites in the field of view (shaded) on day 18 do not have expired data sets. In FIG. 6b, the ephemeris extension file is considered not to be valid as the number of the satellites used in positioning (shaded) on day 18 that do not have expired data sets is less than the threshold.

If the determination in step S2 is that the ephemeris extension file is valid, then steps S3 and S4 are skipped.

If the ephemeris extension file is not valid, then the receiver 130 requests ephemeris extension data from the server 108 at step S3.

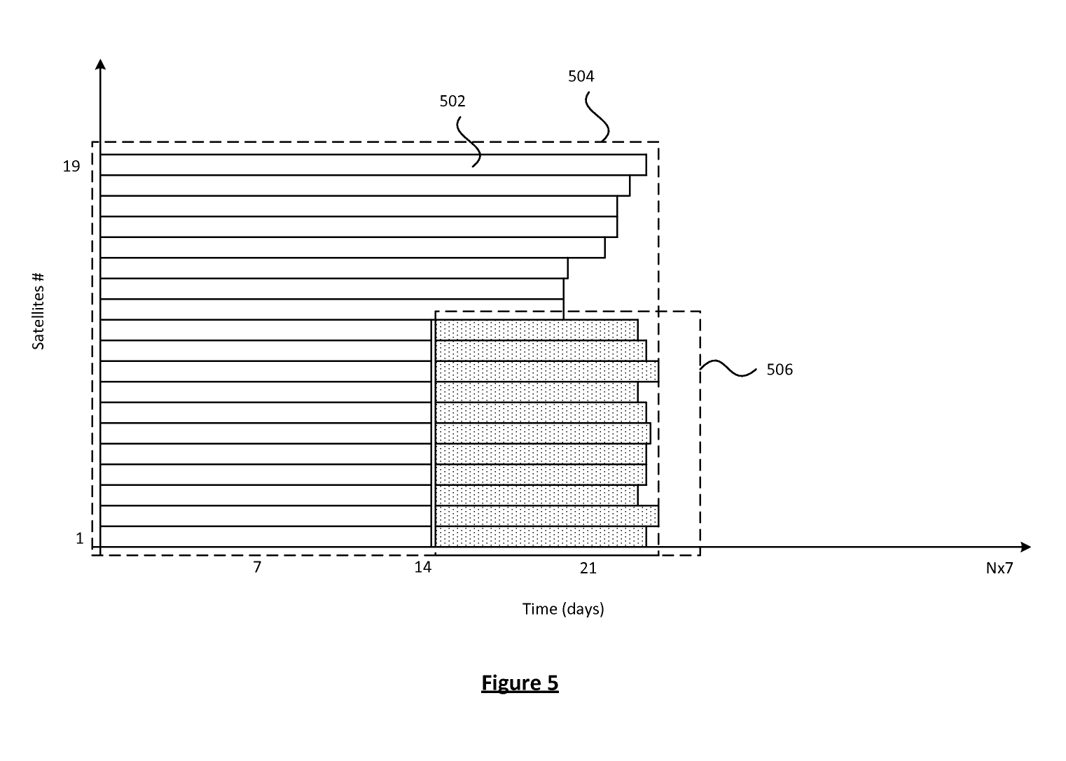

In some embodiments, the ephemeris extension for the expired ephemeris extension data only is requested at step S3. This is shown in FIG. 5. Here, data sets for satellites for which ephemeris extension data had expired is received from the server 108 at step S4 and is used to overwrite the corresponding data sets in the ephemeris extension file 150. In these embodiments, the request indicates the satellites for which ephemeris extension data is required. This may be achieved by identifying the satellites by a unique identifier. As such, the request may list the identifiers of plural satellites.

In other embodiments, a replacement ephemeris extension file 150 is requested at step S3. Here, the ephemeris extension file delivered at step S4 includes data pertaining to all satellites. This is shown in FIG. 4. Here, the ephemeris extension data sets sent to the receiver 130 are prediction data pertaining to all 19 satellites in the example constellation. Data sets for all satellites is received from the server 108 and is used to overwrite all the data sets in the ephemeris extension file 150.

The receiver 130 is configured to analyse the measurement residuals in the position calculation routines. If one or more of the measurements have high residual error compared to the approximate location or majority of the measurements, the satellites providing a high residual error can be determined to be erroneous and then be excluded from the calculations.

Transmitting data sets only for satellites for which the ephemeris extension data has expired 506 (FIG. 5) reduces the amount of data needed to be transferred from the server 108 to the receiver 130 compared to the alternative of sending all data sets (FIG. 4).

In step S5 the received ephemeris extensions are used by the receiver 130 along with positioning signals received from the satellites in view to determine the location of the receiver 130.

The server 108 services many receivers 130, in the sense that it provides ephemeris extension data to a great number of receivers 130.

In some embodiments, the receiver is a GNSS receiver, configured to receive signals from satellites of two or more constellations and to calculate its position using signals received from satellites in different constellations. In these embodiments, ephemeris extension data for each satellite has its own expiry date. In these embodiments, ephemeris extension files for one constellation are sent separately to files for other constellations.

The above-described system and method of operation provides some effects, as will now be described.

The life-time of the ephemeris extensions is adaptive and maximized.

The setting by the server 108 of an expiry date such that the validity period expires just before a rephrasing/orbit change or maintenance event provides an effect of the receivers 130 being provided with information by which they can request updated ephemeris extension data after the event. When there are major changes in the satellite constellation (new satellites, rephasing etc), the system will adapt to the situation and will provide e.g. only very short predictions.

In the case where the satellite network is not updated, the prediction period could be a much longer length of time. The result of these features is that the load on the servers will become distributed more evenly since the receivers are not requesting ephemeris data simultaneously. The prediction period may be longer for satellites that have good clock performance and may be relatively short for satellites that have poor clock performance. The prediction period may depend also on the stability of the orbit of the corresponding satellite.

A further effect provided by the embodiments is that the receivers can require reduced use of data connectivity resources. This results in power savings for receivers. Where users have expensive data plans, this can also provide cost savings.

The embodiments can be said to be optimised for the “always-on” approach which is the future direction in smartphones, the approach/aim being to keep a satellite positioning receiver in a warm/hot state to minimize time-to-first-fix. This can be said because the receiver may be able to obtain a position fix even though ephemeris extension data may have expired for some satellites. This is particularly useful where the option of obtaining new ephemeris extension data is not possible, for instance because the receiver is outside of network coverage or is roaming in another network.

Another effect of the above-described embodiments is that the exact data flow/size needed for ephemeris extensions cannot be accurately predicted.

This is a more complex approach to the requesting of updates/refreshes from the server may be required compared to approaches taken in the prior art.

Numerous alternatives will be envisaged by those skilled in the art. Some alternative embodiments will now be described.

In some embodiments, ephemeris extension data is calculated in the terminal. Here, the terminal applies e.g. gravity- and force-models to the broadcast ephemeris data, that is received through the terminal's GPS receiver, to extend the life-time of the ephemeris data. Systems in which ephemeris extensions are calculated in the terminal are marketed by Rxnetworks as Self-Assisted GPS (SAGPS) and by SiRF (CSR) as InstantFix II. These known systems provide ephemeris extensions with a fixed validity period, of 3 days. In these embodiments, though, ephemeris extensions may have different validity periods for different satellites.

An effect of these embodiments is that operation can be totally independent from the network.

The local ephemeris extension calculation functionality is implemented as “local server”. Here, a server application is part of the software 144 stored in the receiver 130. The server application is executed by the processor 138 using the RAM 142.

Operation of the receiver 130 in these embodiments is similar to that described above although requests for ephemeris extension files are sent from the GPS receiver formed by the GPS decoder 148 and the processor to the server application 144 running in the receiver 130, which serves ephemeris extension files to the GPS receiver as requested.

In still other embodiments, another terminal 131 (FIG. 1) in the vicinity or somehow distantly in connection with the receiver 130 acts as a server serving ephemeris extension data. Ephemeris extension data can be communicated via a direct connection, for instance wi-fi, Bluetooth, etc., or via the network 118 or a local area network 133.

These other embodiments reduce the overall computational burden since the ephemeris extension data need only be calculated by a server application in one receiver 131. The data can then be shared with other receivers 130. This is particularly useful if the receivers 130, 131 are receiving signals from different satellites, and particularly when the satellites are from different constellations, as can be the case when the receivers are at different locations within a building.

Although the above embodiments relate to a GPS system, the scope of the invention is not limited to this. For instance, the invention is applicable also to other navigation systems involving predictions of satellite data, including the GLONASS, COMPASS, GALILEO, SBAS, QZSS and IRNSS satellite networks as well as to GNSS systems that utilise signals received from plural constellations.

1-36. (canceled)

37. Apparatus comprising:
one or more memories configured to store data sets for each of plural positioning satellites, the data set for a satellite comprising ephemeris extension data and data relating to a lifetime or expiry of the ephemeris extension data, wherein the data relating to a lifetime or expiry of the ephemeris extension data is different for at least two satellites; and
one or more processors configured to execute computer code in the one or more memories such as to perform a method comprising:
identifying one or more satellites for which ephemeris extension data is no longer valid;
identifying one or more satellites for which ephemeris extension data is valid;
determining whether to calculate a location based on the one or more satellites for which the stored ephemeris extension data is valid and, in response to a negative determination:
sending a request for new ephemeris extension data;
receiving new ephemeris extension data;
storing the new ephemeris extension data; and
using the new ephemeris extension data in calculating a location of the apparatus.

38. Apparatus as claimed in claim 37, wherein the computer code is configured to cause the processor to perform determination whether to calculate a location by:
identifying one or more satellites that are currently usable for a location fix;
determining whether valid ephemeris extension data is present for a threshold number of the satellites usable for a location fix;
on a positive determination, using the valid ephemeris extension data to obtain a location fix; and
on a negative determination, requesting new ephemeris extension data

39. Apparatus as claimed in claim 37, wherein the computer code is configured to cause the processor to perform sending a request for new ephemeris extension data by sending a request for ephemeris extension data for at least one of
a) satellites for which ephemeris extension data is no longer valid, Or
b) all satellites for which ephemeris extension data is no longer valid,
or
c) all satellites for which ephemeris extension data is stored in the mobile device, whether or not the ephemeris extension data is valid.

40. Apparatus as claimed in claim 37, wherein the data relating to a lifetime of the ephemeris extension data indicates at least one of,
a) an expiry time,
or
b)
a validity period and a start time.

41. Apparatus as claimed in claim 37, wherein the computer code is configured to cause the processor to perform receive at least one of,
a) a file comprising plural data sets each corresponding to a different positioning satellite,
Or
b)
plural files, each file comprising a data set for a different positioning satellite.

42. A method comprising:
storing in a mobile device data sets for each of plural positioning satellites, the data set for a satellite comprising ephemeris extension data and data relating to a lifetime or expiry of the ephemeris extension data, wherein the data relating to a lifetime or expiry of the ephemeris extension data is different for at least two satellites;
identifying one or more satellites for which ephemeris extension data is no longer valid;
identifying one or more satellites for which ephemeris extension data is valid;
determining whether to calculate a location based on the one or more satellites for which the stored ephemeris extension data is valid and, in response to a negative determination:
sending a request for new ephemeris extension data;
receiving new ephemeris extension data;
storing the new ephemeris extension data; and
using the new ephemeris extension data in calculating a location of the mobile device.

43. A method as claimed in claim 42, wherein determining whether to calculate a location comprises:
identifying one or more satellites that are currently usable in obtaining a location fix;
determining whether valid ephemeris extension data is present for a threshold number of the satellites usable in obtaining a location fix;
on a positive determination, using the valid ephemeris extension data to obtain a location fix; and
on a negative determination, requesting new ephemeris extension data

44. A method as claimed in claim 42, wherein sending a request for new ephemeris extension data comprises sending a request for ephemeris extension data for at least one of,
a) satellites for which ephemeris extension data is no longer valid,
or
b)
all satellites for which ephemeris extension data is no longer valid,
or
c)
all satellites for which ephemeris extension data is stored in the mobile device, whether or not the ephemeris extension data is valid.

45. A method as claimed in claim 42, wherein the data relating to a lifetime of the ephemeris extension data indicates at least one of,
a) an expiry time,
or
b)
a validity period and a start time.

46. A method as claimed in claim 42, comprising receiving at least one of,
a) a file comprising plural data sets each corresponding to a different positioning satellite,
or
b)
plural files, each file comprising a data set for a different positioning satellite.

47. A computer program comprising machine readable code that when executed by processing means causes it to perform the method of storing data sets for each of plural positioning satellites, the data set for a satellite comprising ephemeris extension data and data relating to a lifetime or expiry of the ephemeris extension data, wherein the data relating to a lifetime or expiry of the ephemeris extension data is different for at least two satellites;
identifying one or more satellites for which ephemeris extension data is no longer valid;
identifying one or more satellites for which ephemeris extension data is valid;
determining whether to calculate a location based on the one or more satellites for which the stored ephemeris extension data is valid and, in response to a negative determination:
sending a request for new ephemeris extension data;
receiving new ephemeris extension data;
storing the new ephemeris extension data; and
using the new ephemeris extension data in calculating a location of the mobile device.

48. A computer readable medium having non-transiently stored therein computer code that when executed by one or more processors of a mobile device causes them to perform a method comprising:
storing data sets for each of plural positioning satellites, the data set for a satellite comprising ephemeris extension data and data relating to a lifetime or expiry of the ephemeris extension data, wherein the data relating to a lifetime or expiry of the ephemeris extension data is different for at least two satellites;
identifying one or more satellites for which ephemeris extension data is no longer valid;
identifying one or more satellites for which ephemeris extension data is valid;
determining whether to calculate a location based on the one or more satellites for which the stored ephemeris extension data is valid and, in response to a negative determination:
sending a request for new ephemeris extension data;
receiving new ephemeris extension data;
storing the new ephemeris extension data; and
using the new ephemeris extension data in calculating a location of the mobile device.

49. A computer readable medium as claimed in claim 48, wherein the computer code when executed by the one or more processors of the mobile device causes them to perform determining whether to calculate a location by:
identifying one or more satellites that are currently usable in obtaining a location fix;
determining whether valid ephemeris extension data is present for a threshold number of the satellites usable in obtaining a location fix;
on a positive determination, using the valid ephemeris extension data to obtain a location fix; and
on a negative determination, requesting new ephemeris extension data

50. A computer readable medium as claimed in claim 48, wherein the computer code when executed by the one or more processors of the mobile device causes them to perform sending a request for new ephemeris extension data by sending a request for ephemeris extension data for a least one of
a) satellites for which ephemeris extension data is no longer valid,
or
b)
all satellites for which ephemeris extension data is no longer valid.

51. A computer readable medium as claimed in claim 48, wherein the computer code when executed by the one or more processors of the mobile device causes them to perform sending a request for new ephemeris extension data by sending a request for ephemeris extension data for all satellites for which ephemeris extension data is stored in the mobile device, whether or not the ephemeris extension data is valid.

52. A computer readable medium as claimed in claim 48, wherein the data relating to a lifetime of the ephemeris extension data indicates at least one of,
a) an expiry time,
or
b)
a validity period and a start time.

53. A computer readable medium as claimed in claim 48, wherein the computer code when executed by the one or more processors of the mobile device causes them to perform receiving a file comprising at least one of,
a) plural data sets each corresponding to a different positioning satellite,
or
b)
a data set for a different positioning satellite.

54. A method comprising creating data sets for each of plural positioning satellites, the data set for a satellite comprising ephemeris extension data and data relating to a lifetime or expiry of the ephemeris extension data, wherein the data relating to a lifetime or expiry of the ephemeris extension data is different for at least two satellites.

55. A computer program comprising machine readable code that when executed by processing means causes it to perform the method of claim 54.

56. A computer readable medium having non-transiently stored therein computer code that when executed by one or more processors of a mobile device causes them to perform a method comprising: creating data sets for each of plural positioning satellites, the data set for a satellite comprising ephemeris extension data and data relating to a lifetime or expiry of the ephemeris extension data, wherein the data relating to a lifetime or expiry of the ephemeris extension data is different for at least two satellites.

57. Apparatus comprising one or more processors configured to execute computer code stored in one or more memories such as to perform a method comprising: creating data sets for each of plural positioning satellites, the data set for a satellite comprising ephemeris extension data and data relating to a lifetime or expiry of the ephemeris extension data, wherein the data relating to a lifetime or expiry of the ephemeris extension data is different for at least two satellites.

58. A method comprising sending data sets for each of plural positioning satellites, the data set for a satellite comprising ephemeris extension data and data relating to a lifetime or expiry of the ephemeris extension data, wherein the data relating to a lifetime or expiry of the ephemeris extension data is different for at least two satellites.

59. A computer program comprising machine readable code that when executed by processing means of sending apparatus causes it to perform the method of claim 58.

60. A computer readable medium having non-transiently stored therein computer code that when executed by one or more processors of a mobile device causes them to perform a method comprising: sending data sets for each of plural positioning satellites, the data set for a satellite comprising ephemeris extension data and data relating to a lifetime or expiry of the ephemeris extension data, wherein the data relating to a lifetime or expiry of the ephemeris extension data is different for at least two satellites.

61. Apparatus comprising one or more processors configured to execute computer code stored in one or more memories such as to perform a method comprising: sending data sets for each of plural positioning satellites, the data set for a satellite comprising ephemeris extension data and data relating to a lifetime or expiry of the ephemeris extension data, wherein the data relating to a lifetime or expiry of the ephemeris extension data is different for at least two satellites.
